(19) United States
(12) Patent Application Publication
(10) Pub. No.: US 2021/0272038 A1
(43) Pub. Date: Sep. 2, 2021

(54) Healthcare Decision Platform

(71) Applicant: NoviSystems, Inc., Cary, NC (US)

(72) Inventors: Michael Kowolenko, Cary, NC (US); John C. Bass, Cary, NC (US); Meaghan E. Johnson, Cary, NC (US); Andrew Brown, Cary, NC (US); Michael S. Brown, Cary, NC (US); Jesse Simpson, Cary, NC (US)

(21) Appl. No.: 17/321,200

(22) Filed: May 14, 2021

Related U.S. Application Data
(63) Continuation-in-part of application No. 16/453,805, filed on Jun. 26, 2019.

(51) Int. Cl. G06Q 10/06; G06F 40/20; G06K 9/62; G06N 20/20; G06N 20/10

(52) U.S. Cl. CPC G06Q 10/06316; G06F 40/20; G06N 20/10; G06N 20/20; G06K 9/6292

(57) ABSTRACT

A system for the dynamic analysis of unstructured data where feedback loops exist between the user and the machine resulting in improved specificity and content (accuracy and precision) with regard to the results obtained from the machine learning algorithms. A Graphic User Interface (GUI) controls the configuration and deployment of all the features of the Intelligence Augmentation System (IAS) including data capture and processing, analytics, and feedback. Results of one set of algorithms can be forwarded to subsequent tools with the system for further analysis and planning using decision algorithms. The results are configured using a GUI that can manipulate the data in dynamically, allowing immediate visualization of user queries.

### CLAIM TO PRIORITY

This application claims under 35 U.S.C. §120, the benefit of the application Ser. No. 16/453,805, filed Jun. 26, 2019, titled “Intelligence Augmentation System for Data Analysis and Decision Making” which is hereby incorporated by reference in its entirety.

### COPYRIGHT NOTICE

A portion of the disclosure of this patent document contains material which is subject to copyright protection. The copyright owner has no objection to the facsimile reproduction of the patent document or the patent disclosure, as it appears in the Patent and Trademark Office patent file or records, but otherwise reserves all copyrights whatsoever.

### BACKGROUND

Data Mining is the process of extracting insight from large amounts of structured data where features have been predefined. This type of data is often found in databases and collections of databases (e.g., data warehouses). Textual or unstructured data such as free formed text where features are derived by the reader familiar with the content and context of the words written in documents can be mined for content classification or fact extraction. Unfortunately, many software systems for analytics and machine learning focus on specific domains. The challenge is designing a system that can be used by business users with little experience in data sciences to extract relevant information and perform analysis and visualization of the results.

Unstructured text data mining is often used by business intelligence organizations to capture public perceptions regarding products, events, etc. It has been used in healthcare to extract information from electronic medical records, and in law enforcement to extract information regarding crimes.

Healthcare providers often deal with multiple sources of data required for decision making. These can consist of electronic medical records EMR, enterprise resource planning systems ERP, databases, spreadsheets, or flat files of electron media such as documents or reports. For example, a hospital or clinic may keep its patient information in an EMR, the information regarding staff payroll and human resource data in an ERP system, and facilities management data in an inventory management and logging database. To develop a holistic view of operations, the administration needs to view how these resources are interrelated in order to optimize care of the patient while maintaining an optimal cost structure and quality of care. Other data sources may be required by decision makers and the system described must have the capability of capturing and processing these additional sources of information.

Historically, institutions have had to extract data from these individual data sources manually then combine manually using tools such as spreadsheets. This has many disadvantages. Medical records that are pooled by diagnosis or end points often lack specificity and context regarding the ability to drive decision making. Having the ability to apply additional filtering tools such as natural language processing provides the ability to improve insight into the characteristics of patients that are under investigation. ERP systems and relational databases can be queried using common database query language tools such as sql, the challenge is in finding the human resources in a timely manner that can perform the task for a business analyst.

### BRIEF DESCRIPTION OF THE DRAWINGS

Certain illustrative embodiments illustrating organization and method of operation, together with objects and advantages may be best understood by reference to the detailed description that follows taken in conjunction with the accompanying drawings in which:

FIG. 1 is a view of an Intelligence Augmentation System (IAS) features consistent with certain embodiments of the present invention.

FIG. 2 is a view of the IAS system configuration consistent with certain embodiments of the present invention.

FIG. 3 is a flow diagram for data import into the system consistent with certain embodiments of the present invention.

FIG. 4 is a flow diagram for building and/or updating one or more dictionaries for use by the system consistent with certain embodiments of the present invention.

FIG. 5 is a flow diagram for word tokenization and analysis consistent with certain embodiments of the present invention.

FIG. 6 is a flow diagram for machine language preprocessing to build training data sets consistent with certain embodiments of the present invention.

FIG. 7 is a flow diagram for training data processing and use consistent with certain embodiments of the present invention.

FIG. 8 is a flow diagram for machine language field definition and update consistent with certain embodiments of the present invention.

FIG. 9 is a flow diagram for selection and use of machine language algorithms during analysis of incoming dictionaries consistent with certain embodiments of the present invention.

FIG. 10 is a view of a knowledge graph data table used in data analysis consistent with certain embodiments of the present invention.

FIG. 11 is a view of a FHIR query processing capability consistent with certain embodiments of the present invention.

FIG. 12 is a view of a FHIR import processing capability consistent with certain embodiments of the present invention.

FIG. 13 is a view of a machine language functionality processing capability consistent with certain embodiments of the present invention.

FIG. 14 is a view of a machine language parameter input process consistent with certain embodiments of the present invention.

FIG. 15 is a view of a process for the creation of a new corpus definition consistent with certain embodiments of the present invention.

FIG. 16 is a view of a machine language analysis process consistent with certain embodiments of the present invention.

FIG. 17 is a view of a process for performing training of a machine language analysis capability consistent with certain embodiments of the present invention.

### DETAILED DESCRIPTION

While this invention is susceptible of embodiment in many different forms, there is shown in the drawings and will herein be described in detail specific embodiments, with the understanding that the present disclosure of such embodiments is to be considered as an example of the principles and not intended to limit the invention to the specific embodiments shown and described. In the description below, like reference numerals are used to describe the same, similar or corresponding parts in the several views of the drawings.

The terms “a” or “an”, as used herein, are defined as one or more than one. The term “plurality”, as used herein, is defined as two or more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

Reference throughout this document to “one embodiment”, “certain embodiments”, “an embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

Data is considered to be a set of values of subjects in a digital format that is storable and transmissible by computer systems.

The database is an ordered collection of data stored in a digital format on a computer system. Databases are maintained by database management systems (DBMSes). Queries to some databases are codified in the Structured Query Language (SQL).

The programming language is a formal language which comprises a set of instructions that produce various kinds of output. Programming languages are used in computer programming to implement algorithms.

The operating environment is composed of the operating system, communications software, software utilities, and platform software necessary for users to run application software.

The computer system is a set of devices that execute computational operations, store data used for input to computational operations and which are generated from computational operations, and transmit and receive data to and from other computer systems.

The use of lemma in this document refers to a heading indicating the subject or argument of a literary composition, an annotation, or a dictionary entry.

The use of Machine Learning (ML) in this document refers to one or more learning systems capable of identifying and processing fields in unknown input data to classify and predict the future state of the input data upon being trained in the definition and analysis of one or more training data sets by one or more human users.

The Healthcare Decision Platform (HDP) system is an integrated system for extracting information from healthcare related systems necessary for decision making. The system, a series of software algorithms that receives input from the user via a graphical user interface GUI resulting in the aggregation of information data fusion using tools such as natural language processing NLP that can be analyzed for relationships or classifications of relationships by machine learning algorithms.

In an embodiment, many analytical applications have the capability of analyzing aggregate views of data but are unable to perform analytics requiring real time join functions between different data tables and allow the user to see the results of analysis under these dynamic conditions. The opportunities in “Big Data” are the fusion of these data sets, however most database systems require complex join functions and extensive understanding of structured query language (SQL) to derive analytics and insights from the aggregate data views.

In the embodiment herein described, if the system can extract text from the EMR system and apply natural language processing NLP to the output, it can assist in multiple business processes including review of medical billing coding and justification. For example, billing codes based on the International Classification of Disease (ICD) adapted for the Health Insurance Portability and Accountability Act of 1996 (HIPAA), currently at version 10 have set definitions that can be compared to data that exists in the EMR. Matches provide evidence of treatment as per guidelines.

In addition, the system of text extraction can be coupled with NLP to search medical literature such as PubMed® National Center of BioInformatics (NCBI) to provide data regarding the current standard of care regarding a given diagnosis. This information can then be used to justify the treatment of the patient.

Using data fusion of data from electronic medical records, the data regarding staffing numbers, qualification, and training obtained from the ERP system along with historian data from hospital facilities systems, the quality of care of the patients can be assessed by viewing outcomes based on the integration of these factors. For example, patients clustered by a given disease type and socioeconomic factors, given specific training by one individual have a better outcome than given training by a different individual provides an opportunity to address training programs.

Finally, because the systems' rules-based system can be easily configured, medical staff can easily configure text analytics processes to extract facts from medical records making the identification of patients with defined signs and symptoms straightforward to isolate. Once isolated, quantitative data associated with the patient can be correlated with factors such as outcome, drug treatment, etc. using the built-in machine learning algorithms.

Unstructured text data mining is often used by business intelligence organizations to capture public perceptions regarding products, events, etc. by analyzing textual data input to the system. In non-limiting examples, such text data mining has been used in healthcare to extract information from electronic medical records, and in law enforcement to extract information regarding crimes. The challenge of Unstructured Text Analytics in data mining of text is the ambiguous nature of language. Each domain such as healthcare or crime requires intensive input from the subject matter expert (SME) in order to be effective. An SME may develop the lexicon required by the machine to perform the data mining task on unstructured data.

In an embodiment, the Healthcare Decision Platform HDP comprises 4 major components: Ingestion of data, formation of a common data tables, integrated analytics including NLP and machine learning, and a user configurable interactive Dashboard that can display or process data for further analytics and display. Many of the components have been described in patent application “An Intelligence Augmentation System for Data Analysis and Decision Making” Docket ID: NOV-npr-001, which is included by reference herein in its entirety.

In an embodiment, the IAS comprises six major components. The first of these encompasses the data capture for use by the system. Data exists in many formats, such as text documents (multiple formats; xdoc, txt, csv, html, web crawls) binary files (PDF), or in structured data formats (databases, xml,) that enumerate relationships between data fields and elements. In the IAS system, data stored on local networks or available on the web can be accessed by the IAS system when proper communications are established and data access is by default, such as publicly available data or open data access, or data access is granted by the owner of the data. The data connector to establish the communication and access the required data is built into the system and uses the appropriate database connectors for relational databases and additional pre-configured data connectors for other data types. The system when deployed is configured so that network system administrators provide access to databases, data stores, and file systems.

In an embodiment, for text analysis Data Tables stored in a Data Store can undergo the analysis of input text through the process of text analytics. The intent of text analytics is to extract facts from textual data or to classify text as meeting conditions defined by the user. Text, unlike quantitative data, has a high degree of ambiguity because of the contextual meaning of words. The innovation set forth in this document describes a process where users “seed” the dictionaries with a set of terms, the system compares the terms to a thesaurus, extracts sentences from the corpus of documents and requests feedback. In addition, the system uses machine learning algorithms to supplement the thesaurus resulting in improved specificity and context with relatively low SME input. To improve context and specificity, the integrated system text tool integrates data preparation, novel approaches to dictionary supplementation, and machine learning to provide contextually relevant fact extraction and classification of documents.

Selection of Natural Language Processing on the home page provides the functionality for implementing Natural Language Processing. Natural Language Process workflow offers the user two choices, a rules-based system using dictionaries, or machine learning. In a rules-based system, the system is directed by the user to annotate the document using the dictionaries developed using the Dictionary Editor. The advantage of a rules-based system is that the system will only annotate what has been defined as a term of interest, this term of interest becomes a dictionary term.

In a non-limiting example, to overcome the need for programmers to develop the code necessary for performing the task of annotation, the users are directed to a Dictionary Matrix Table where a data table with its respective fields may be displayed as rows, while each dictionary is displayed as a column. The user simply selects which dictionaries should be matched with which fields. The selection process has the option to be global (all dictionaries, all columns). Following the selection process, the annotation process is initiated and the machine annotates the data in the data table. Output is an index associated with the data table stored in a data store.

The second feature is the intelligence augmentation system deployed for utilizing machine learning. The IAS provides a multifaceted approach to utilizing machine learning that makes use of a feedback loop based on a rules-based system to improve the specificity and context of returns generated by the machine learning algorithms. The concept is that the use of dictionaries supplemented with the thesaurus feedback tool isolates facts and/or content of relevance. The identified facts and/or content become the training data for the machine learning algorithms.

The system generation of training data can be a tedious, time consuming process requiring manual annotation of documents. To overcome this issue, the system utilizes the output from a rules-based system coupled with part of speech (POS) analysis to generate phrases that have the appropriate specificity and context for the domain under investigation. The dictionaries provide the specificity, use of POS improves context as placement of terms in noun-verb-noun relationships uses rules of grammar to improve the relevancy of the terms that are used as either positive or negative training data in the machine learning models. These activities are performed on specific fields selected from the cleaned text, where cleaned text consists of known text fields and known contextual references for the text fields.

In an embodiment, the machine-learning learning system included with the IAS provides the user with information concerning topics that were not readily apparent to the user. In a non-limiting example, if the user developed dictionaries that isolated phrases that contained information concerning demographics and purchases, the rules-based system may retrieve facts such as “single males that purchase skateboards” if the noun for the verb purchase was restricted to skateboard and skateboarding items. The machine learning model may return a list of potential purchase items including skateboards but would expand that list to possible items contained in the documents such as cars, music, etc. that may be contextually relevant to those individuals that have historically purchased skateboards. The user can then request that one or more of the newly presented potential purchase items be added to the data table.

The text tools deployed with the IAS enable the user to develop models for fact extraction and text classification without a deep understanding of programming. The system relies on the user's expertise in the field to initiate the process and provide feedback to develop models for data extraction and text classification. The system is vertical agnostic and can be used by any subject matter expert.

In an embodiment, the IAS can perform classification and prediction calculations of user data through instantiating a series of algorithms that may be provided inputs generated by the preprocessing routines. The preprocessing routines receive input from a feedback system consisting of a user interface, the data under investigation, and the aforementioned routines. In addition, the system must be informed if the data model required is supervised or unsupervised learning. The user is prompted to characterize the query. Once filtering is complete and data visualized, the filtered data can be sent to directly to the machine learning algorithms.

This user input allows the IAS to select the appropriate set of machine learning algorithms to apply to the problem. The data is organized as a series of columns. The selection of a column represents the value a user wants to classify and/or predict without showing how the other data columns or features contribute to the analysis/prediction. This data isolation leads to the application of supervised learning algorithms where a selection of one column of data while requesting data grouping in an attempt to cluster data “likes”, where a “like” may be a similarity between two fields or data groups that permits the analysis of data to be performed more efficiently, may direct the system to supervised or unsupervised learning algorithms to optimize the processing of the data without requiring programmer intervention.

In an embodiment, the IAS has a GUI that allows non-programmers to develop queries of structured and unstructured data processed by the IAS algorithms.

The system employs a user interface to direct the user to add data analysis functions called widgets to the display using simple drag and drop user interface cues.

The configuration of the data display is referred to as a dashboard. Each dashboard is associated with a primary data table in the data store. During the data import process, the system may automatically import key relationships that exist in database tables and the system may allow the user to define new relationships in data tables imported into the IAS. Automatically importing key relationships increases the user's ability to define relationships between data sets without the need of a programmer.

In an embodiment, the system has the ability to generate knowledge graphs through the use of the dashboard application. Knowledge Graphs are useful in the visualization of relationships between entities. The Knowledge Graphs can also display distance relationships between entities. In a non-limiting example, the system uses the ability of NoviLens, a natural language processing capability native to the IAS, to filter data through the NLP annotation process and Machine Learning algorithms that may provide the data tables for the widgets. This function takes the filtered results and via a user interface, prompts the user for relationships between features.

In an embodiment, the objective extraction and analysis of facts addresses many of the activities required by business analysts. However, there is a need for a somewhat subjective methodology in determining prioritization of decision making. In a non-limiting example, the decision on what automobile to buy may be driven by different priorities depending on the purchaser. A family of six has different requirements than a single person with regard to seating capabilities. A framework to manage these decision priorities has been built into the IAS system. This model uses the NLP and filtering capabilities of the IAS to collect and isolate the necessary facts. The IAS may then apply a series of weighted order decision algorithms to the data. Another unique feature is the user interface that allows the user to determine categories and scores as well as weights, then run “what if scenarios” to determine how changing preferences can change outcomes.

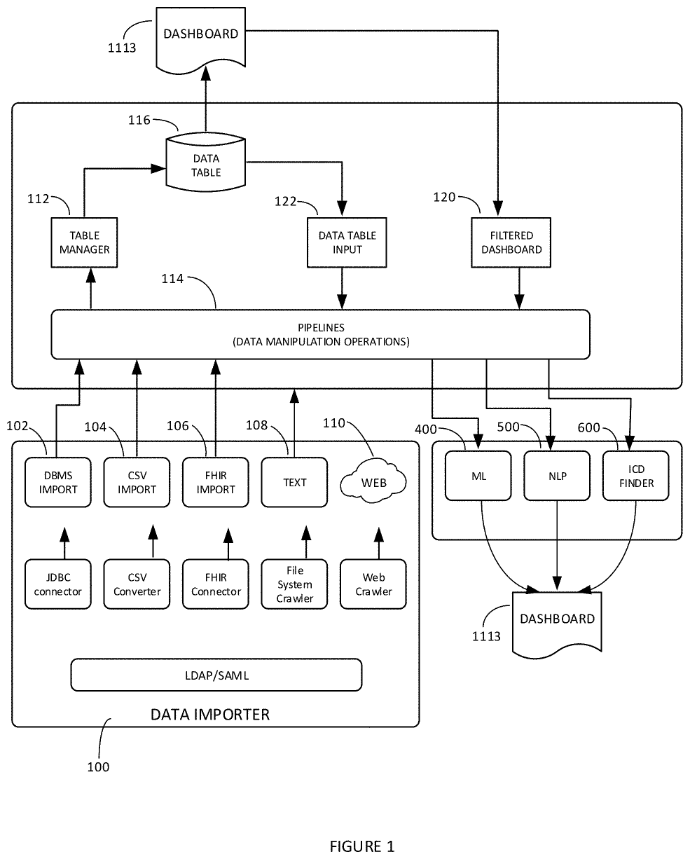

Turning now to FIG. 1, this figure presents a view of an Intelligence Augmentation System (IAS) features consistent with certain embodiments of the present invention. In an exemplary embodiment, the IAS accesses data from a number of online and network connected data repositories to import the data into the system for processing and analysis. In non-limiting examples, data may be sourced from the web 100 through the use of a web crawler 102, access data from text documents 104 through the use of a text document crawler 106, access data from relational database files 108 through the use of a database connector 110 with permission from the owner of the database files 108, and access comma separated value (csv) database files 112 through the use of a csv converter 114, again with the permission of the database file owner. This list of data sources may in no way be considered the only data sources from which the IAS may derive input data for analysis and processing. Additional data sources may be accessed through the use of additional data access methods.

In an embodiment, the incoming data from all data sources may be normalized and processed to be added to one or more data stores 116. A data store may be selected by a user for text processing and analysis 118 to discover textual data that conforms to one or more conditions expressed by a user for analysis. The data in the data store may also be accessed for quantitative analysis 120 and processed for decision support 122, again based upon parameters input and established by a user. After processing by any or all methods is complete, the processed data from the data store may be formatted for visual presentation 124 to the user.

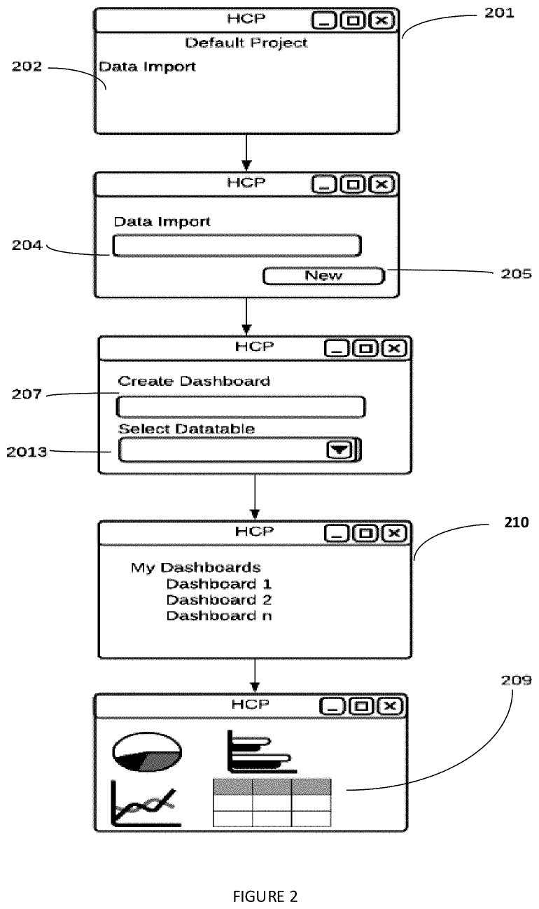

Turning now to FIG. 2, this figure presents a view of the IAS system configuration consistent with certain embodiments of the present invention. In an exemplary embodiment, the system presents a novel method to overcome the need for programming, the system user interface 200 is based on the NoviSystem advanced data modeling system (ADMS), consisting of a high level programming function utilizing an object reference model that translates the criteria of data analysis established by the user into automatically generated processing steps in the form of SQL commands. This innovation results in the generation of a data table 202 that becomes the source of data for analytical queries and/or further data processing. The use of the ADMS provides flexibility in user functionality. Queries do not need to be designed to be domain specific. Rather, the model can be adapted to the data set that is being imported 204 regardless of whether the data was imported from formats such as text, csv records, database records, or any other pre-established data file format. New data 205 may be attached as generated in various pre-established data file formats. Furthermore, while a classic static database query system may require predefined primary and foreign keys to be maintained and may limit the ability to fuse multiple data sources, this approach allows disparate data types to be joined. The data generated as the new Data Table 202 is stored in a relational database 2013. The system may present a create Dashboard 207 option to a user permitting a user to select database tables to be presented in a Dashboard 207 view to a user. The Dashboard view 210 may present the user with a choice of Dashboards to be displayed. If a Dashboard is selected, it can be configured with data widgets 209.

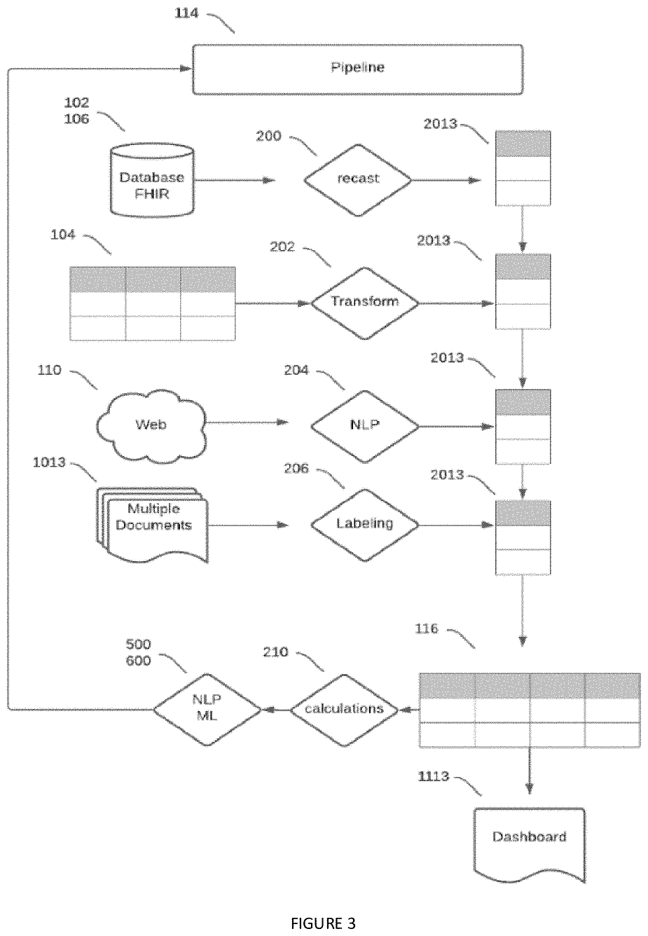

Turning now to FIG. 3, this figure presents a flow diagram for data import into the system consistent with certain embodiments of the present invention. The data pipeline 114 performs a series of high-level compute functions. In an exemplary embodiment, the system presents a novel method to overcome the need for programming, the system user interface 200 is based on the NoviSystem advanced data modeling system ADMS, consisting of a high-level programming function utilizing an object reference model that translates predefined SQL commands into automatically generated processing steps that meet the criteria of data analysis established by a user. This innovation results in the generation of a data table 116 that becomes the source of data for analytical queries and/or further data processing. The use of the ADMS provides flexibility in user functionality. Queries do not need to be designed to be domain specific. Rather, the model can be adapted to the data set that is being imported regardless of whether the data imported is formatted as text, csv records, database records, or any other pre-established data file format. Furthermore, while classic static database query systems may require predefined primary and foreign keys to be maintained and limit the ability to fuse multiple data source, this approach allows disparate data types to be joined. The data generated as the new Data Table 116 is stored in a relational database.

In an embodiment, the tasks performed by the pipeline are defined as follows: data may be imported from a variety of sources such as Databases 102, FHIR APIs 106, csv files 104, or the Web 110. The system, using a GUI queries the user regarding how data should be processed. This includes but is not limited to recasting 200, transformation 202, pre-processing for natural language processing 204, labelling or any combination thereof 206. Units from individual tables 208 can be recombined to form new tables 116 that can now undergo further quantitative analysis 210, machine learning 500 or natural language processing 600.

In this embodiment, resultant Dashboards 1113 are generated by the user using a dropdown configuration menu. The HDP has a GUI that allows non-programmers to develop queries of structured and unstructured data processed by the HDP algorithms.

The system may use a series of drop down menus to direct the user to add data analysis functions to the display using screen position as a guide to where banners place query activities as rows across the top of a page while columns allow the user to configures the display into any number of columns. Each column may contain a separate analytic widget 2013.

The selection of Natural Language Processing 500 on the project page provides the functionality for implementing Natural Language Processing. Natural Language Process workflow offers the user two choices, a rules-based system using dictionaries 501, or machine learning 600. In a rules-based system, the system is directed by the user to annotate the document using the dictionaries developed using the Dictionary Editor 501. The advantage of a rules-based system is that the system will only annotate what has been defined as a term of interest, this term of interest becomes a dictionary term.

The Natural Language Process rules-based system can readily adapt to other lexicons such as SNOMED and MedDRA 1013. Definitions from Healthcare/LifeSciences groups such as the National Center of Bioinformatic that contain dictionaries or lexicon can be imported into the system for use in the system, improving the specificity and context of search results tailored to the needs of the user.

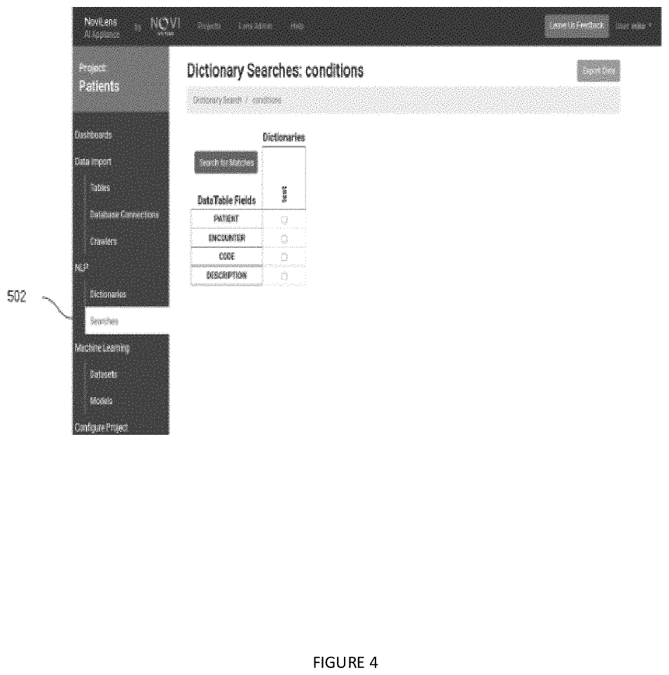

Turning now to FIG. 4, this figure presents a flow diagram for building and/or updating one or more dictionaries for use by the system consistent with certain embodiments of the present invention. In an embodiment, to overcome the need for programmers to develop the code necessary for performing the task of annotation, the users may open a Directory Matrix Table where a data table with its respective fields may be displayed as rows, while each dictionary is displayed as a column. The user simply selects which dictionaries should be matched with which fields. The selection process has the option to be global, connecting with all dictionaries, and all columns. Following the selection process, the annotation process is initiated and the machine annotates the data in the data table. Output is an index associated with the data table stored in a data store.

In a non-limiting example, the system enables the definition of terms that describe the signs and symptoms of a patient suffering from a rare disease. The dictionary may consist of terms referring to physical signs such as “situs inversus” or “infertility”, quantitative data such as lab tests, or frequency of observations. These rules-based extractions when combined are labeled with the potential diagnosis defined by the user.

In an embodiment, rules-based systems may not be based on statistics, but, rather, on token matching. In this case, the dictionary term is the token. The compute function is the matching of the token present in the dictionary with the presence of the token in the input data, the function initiated by selecting Searches 502.

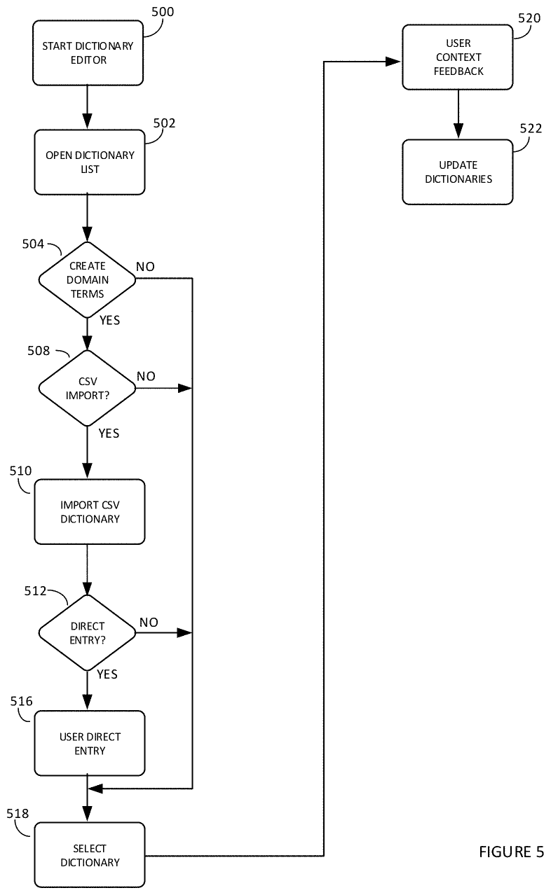

Turning now to FIG. 5, this figure presents a flow diagram for building and/or updating one or more dictionaries for use by the system consistent with certain embodiments of the present invention. In an exemplary embodiment, the Text tool system begins by the user selecting the Dictionary Editor 500 on the GUI Project page. This opens a listing of the dictionaries available in the application 502. A dictionary is a collection of terms that have a similar meaning, for example, disease would use a dictionary of terms associated with “disease” such as sick, ill, illness, etc. The user can create a new dictionary 502 by requesting and utilizing domain terms of importance to the user 504. The system also may inquire of the user at 508 whether the system is to import a list of terms as a csv file. If the user selects this option, the system may import a list of terms as a csv file 510. Selecting csv import opens a new window and that allows the user to browse the file system and select a preconstructed csv file containing terms of interest. Once selected, the file is imported. The user may also, alternatively or in conjunction with the imported csv file select direct entry of terms at 512. If the user selects the option to enter terms directly, the system provides a data entry capability to permit the user to enter the terms and/or words 512 in the spaces provided.

Dictionaries can be edited by selecting the dictionary in the GUI. The development of dictionaries can be a tedious process. To improve the efficiency of the process, selecting a dictionary 516 provides the user with several options; viewing suggestions, view raw data, or delete.

Selecting suggestions initiates the thesaurus review process where the terms in the dictionary are compared to a thesaurus contained in the application. The synonyms, hyponyms, and hypernyms are then annotated in the data table along with the original dictionary terms. A sample of the sentences containing the original terms and synonyms and are presented to the user 518. The user can then review these sentences and determine if the context of the terms is appropriate and provide guidance as to appropriate terms as feedback to the system 520. If appropriate, the terms are added to the dictionary 522. The thesaurus process functions on textural data using a series of algorithms that are python-based but can be deployed using java.

In the case of ICD-10 code verification, the system has been pre-loaded with dictionaries consisting of the ICD-10 definitions for each category of disease, drug, and neoplasia. In addition, the system is capable of cross-referencing MESH terms to identify synonyms for terms written in the emr, not recognized as terms in the definitions of ICD-10 standards.

The system has logic to filter ICD terms based on the text in the medical record. It recognizes the gender of the patient, negating gender-specific diseases for inclusion. It also handles anaphoras, disregarding diagnostic terms presented such as “does not have”, “no sign of”.

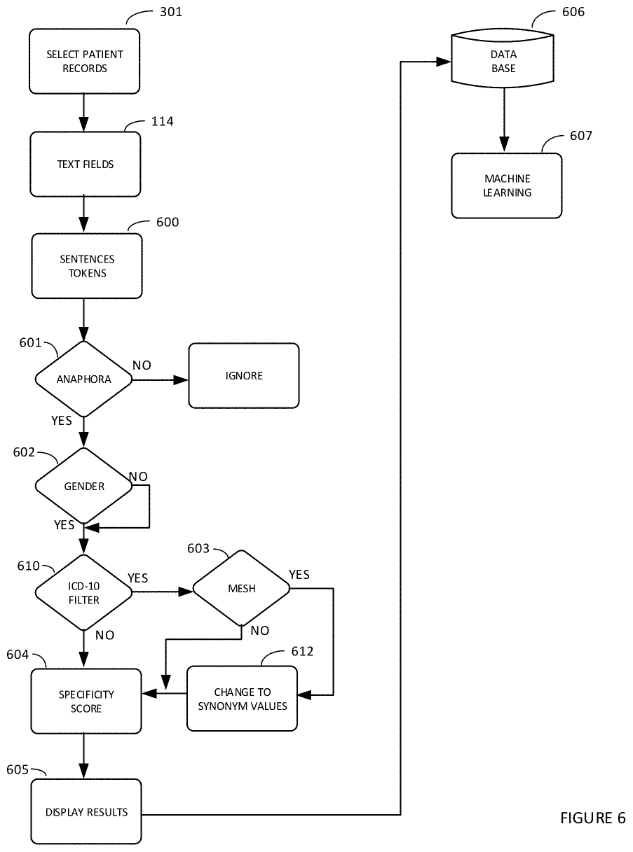

Turning now to FIG. 6, this figure presents the sorting and matching process performed by the system for ICD-10 Codes. Briefly, the user selects the patient record using the FHIR importer 108. The selected patient record 301 is then processed by the pipeline 114 into sentences and tokens for use by the ICD finder 600. Once entering the process, the text is evaluated for the presence of anaphoras 601. If present, the sentence is discarded. The next step is for the sentence to be categorized as being associated with male or female based on text tokens 602.

The sentence and its label are compared to ICD definitions 610, if there are matches, the sentence is scored 604. If there is no match the descriptors between the sentence and the ICD definition, the sentence is compared to MESH terms that are cross referenced with ICD definitions 603. These are viewed as synonyms. Recommendations for coding choices are now based on the synonym values 612.

The system generates a specificity score 604 based on the number of descriptors and modifiers present in the medical record when compared to the definition of the disease described in the ICD-10 description. This allows the user to quickly scan through the results 605 and determine which terms may be used for billing purposes 606.

An innovation in the HCP is that the results can be forwarded to the Machine Learning platform as a labelled dataset 607 where classification algorithms are used to further refine the HCP ability to classify text appearing in the EMR. This combination of a rules-based system with Machine Learning greatly enhances the efficiency of the system.

Speed and accuracy is essential in processing claims. The GUI is designed to allow the user to eliminate categories by selecting a displayed potential match then selecting the “delete” feature. All choices in that category are removed, clearing the viewing field. In addition, if the reviewer needs an in-depth view of the ICD-10 description, the reviewer can “click” on a recommended definition. The ICD-10 definition will appear in the display window where the user can select a billing code if applicable.

All selected billing codes can be printed to a csv file along with the patient name, id, or any other data contained in the emr. The data can be made available as an API endpoint for use in the hospital or clinic's database billing system 606.

In an additional embodiment, the HDP augmentation system may be deployed for utilizing machine learning. The HDP provides a multifaceted approach to utilizing machine learning that makes use of a feedback loop based on a rules-based system to improve the specificity and context of returns generated by the machine learning algorithms. The concept is that the use of dictionaries supplemented with the thesaurus feedback tool isolates facts and/or content of relevance. The identified facts and/or content become the training data for the machine learning algorithms.

This is especially useful for determining the standard of care for patients. The system can “read” the diagnosis, medications, and treatment from the medical record fields in the emr as well as extract the same from the description from the observations within the text from the emr. Using this data, the system links to a peer reviewed source of medical information, PubMed, isolating abstracts from PubMed regarding standard of care for the same disease found in the medical record. The system then uses natural language processing to compare the content of the emr with the data in the abstract. Similarities between the articles and the patient record are presented to the reviewer as evidence for either refuting or supporting the current treatment of the patient.

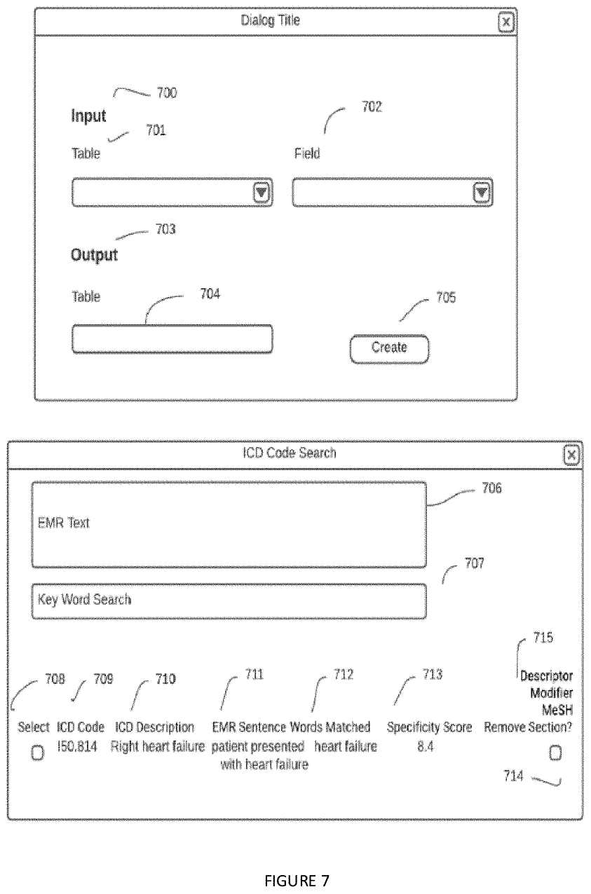

Turning now to FIG. 7, this figure presents a GUI that directs the code finder functions in the HCP. The input data to be analyzed 700 is a table generated by the FHIR crawler. The table can be selected from the dropdown list 701 and the field to be analyzed from the dropdown list 702. The output 703 of the analysis will be saved to a file named by the user 704 once the create button is selected 705.

This triggers a new dropdown where the selected text is displayed in the window 706 and the machine begins the analysis algorithm. The results are displayed in a table where the ICD code is displayed 709, the ICD definition id displayed 710 as is the evidence from the EMR 711. Matched terms are displayed 712 as is the Specificity Score 713. The user can either accept the return using the Select box 708 or remove the Section 715. In addition, the terms are highlighted according to matching definitions for MeSH terms, modifiers, and descriptors 715 derived from the ICD-10 definitions and MeSH Lexicon.

If the returns do not match or alternative terms need to be searched the key word search function 707 can be deployed. In addition, right-clicking on the ICD Description 710 exposes a table defining the ICD-10 full description of all parameters associated with that ICD-10 standard.

Once selected 708, data is written to the file specified in 704 and can be further processed by the pipeline.

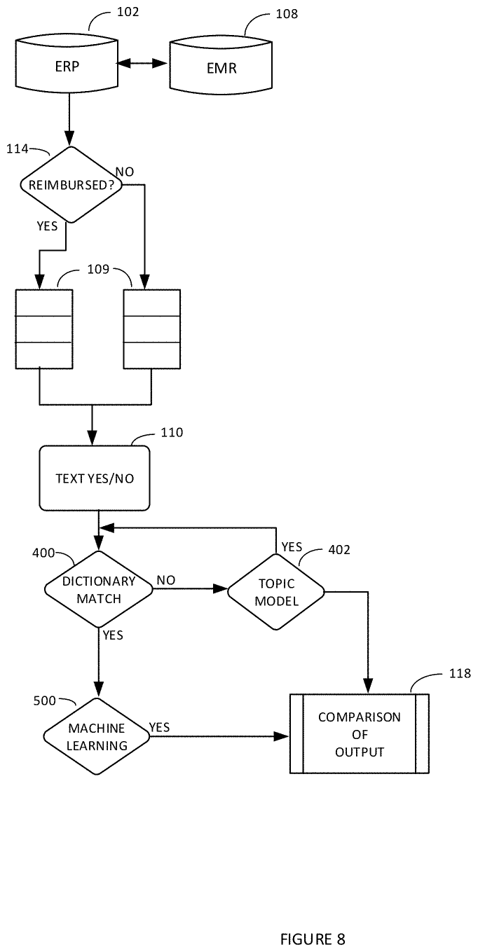

Turning now to FIG. 8, this figure presents a flow diagram that describes how the HCP assists in determining standard of care: data regarding rejected and accepted claims are retrieved from the hospital billing system 102. These data are now joined with emr data via the FHIR importer 108 using the pipeline 114. Using the dashboard tools 109, select text is matched using the NLP tools 500. Based on these results, the user selects an autoconfigured web crawler for reference data such as PubMed® 110 to discover applicable text information. The data is processed by the data pipeline 114 using the same configuration used for the emr data.

Comparing accepted versus rejected claims can be performed by the system. Using the file reading feature of the system, rejected and accepted claims are placed into the system. Using NLP, dictionaries are generated 400 regarding diseases and treatments or designed based on criteria designed by the user. In addition, the dictionaries are supplemented by machine learning classification algorithms 500. This process utilizes parts of speech POS analysis combined with topic modelling 402 to improve context and specificity. Comparing accepted to rejected claims reveals the differences in content between the two groups 118. The system can then be used to “fetch” the necessary data from the emr system using the FHIR interface.

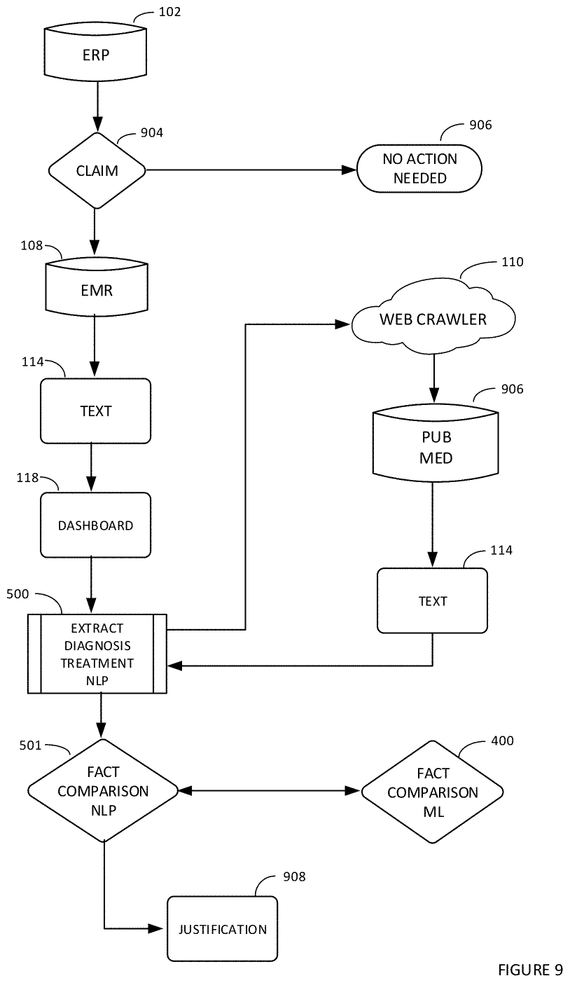

Turning now to FIG. 9, this figure presents a flow diagram that describes this system. An embodiment of the system is the user selecting all claims for a given disease such as chronic myelogenous leukemia in the hospital ERP system 102 and sorting by rejected and accepted claims 904. If the claim is accepted, there is no further action required 906. The user then uses a series of dictionaries that list FDA approved medications, a dictionary for treatments such as radiation and surgery and isolating the sentences in the emrs of the patients whose claims have been accepted or rejected 108.

The system with input from the user will now collect abstracts from PubMed that are selected based on the key terms “standard of care” or similar phrase as well as the disease. In this case, chronic myelogenous leukemia. The NLP algorithm performs the same task of assessing the abstracts and isolating the sentences containing the dictionary terms. In addition, both sets of documents are assessed using topic modelling as one example of a classification algorithm based on the dictionaries/POS analysis to reveal any other similarities and differences.

Both groups of sentences are now compared for overlap. Matching drugs and treatments between the patient and the articles are indicative that the standard has been met. Conversely, if the same treatments have been administered but the patient has remained unresponsive, it is indicative that alternative treatment may be warranted.

Determining the quality of care requires the fusion of data from multiple data sources in order to provide a holistic view of patient care. The system, with its multiple database connector types coupled with analytic capabilities and machine learning provides the necessary functionality to business users to perform this task.

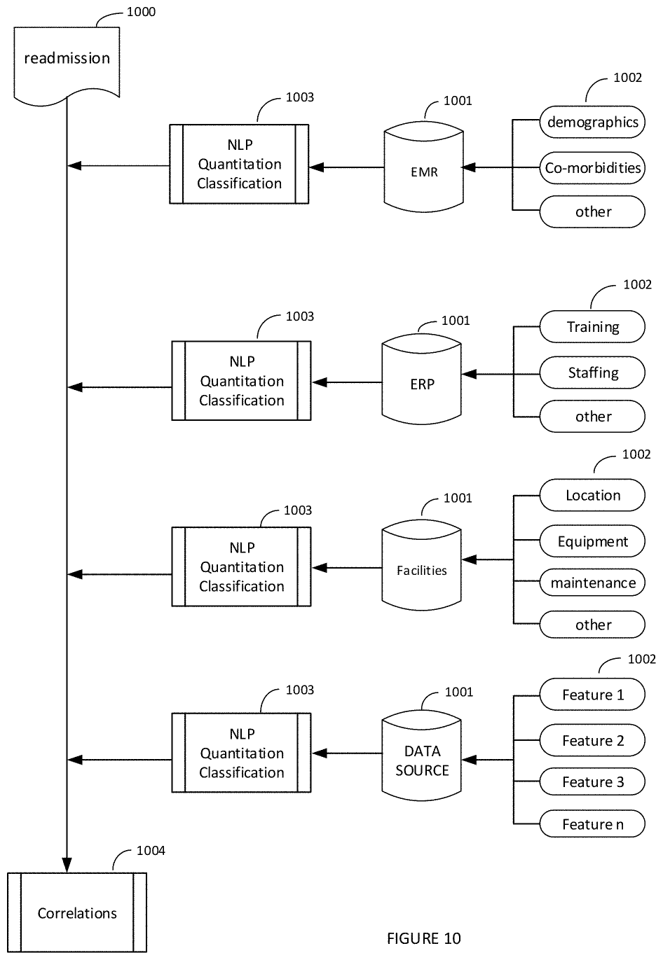

Turning now to FIG. 10, this figure presents a description of how the HCP innovation achieves this goal. Readmissions are extracted from the ERP system and the patient's name and features 1002 are extracted from the EMR system 1001 using the HCP pipeline 1003. A similar process is used for other database systems that can be used to establish common points of intersection between the patient and treatment. The extracted data is processed by the pipeline 1003 then displayed as analytical widgets in the Dashboard 1004. This now provides the user with possible correlations between readmission and causal factors leading to readmissions

A principal innovation of the HCP is the ability to perform analytics without the need for programmers or developers.

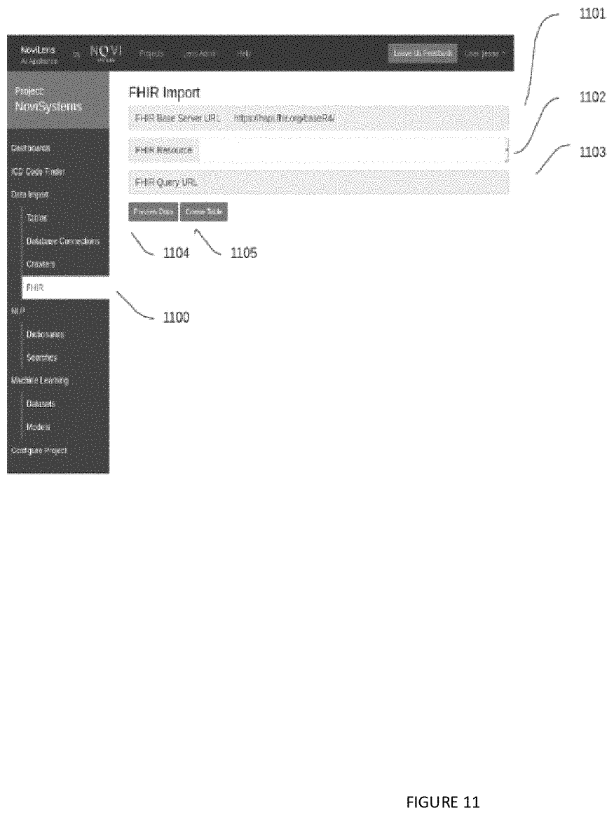

Turning now to FIG. 11, this figure presents a description of how the system allows non-programmers to access data on EMR systems that are FHIR compliant.

The UI provides the user with access to the FHIR data acquisition system 1100. The user then connects to the appropriate EMR system using the URL name provided by the hospital/clinic EMR administrator 1101. This will auto-populate the FHIR resource fields in 1102. An FHIR ape resource will be auto generated 1103. The user can then preview the data that will be brought into the HCP by selecting the “Preview Data” button 1104. If satisfied, the data will enter the system by selecting the “Create Table” button 1105. These tables may now be placed in a Dashboard 114, be processed in ML algorithms, or undergo NLP analysis with subsequent Dashboard generation.

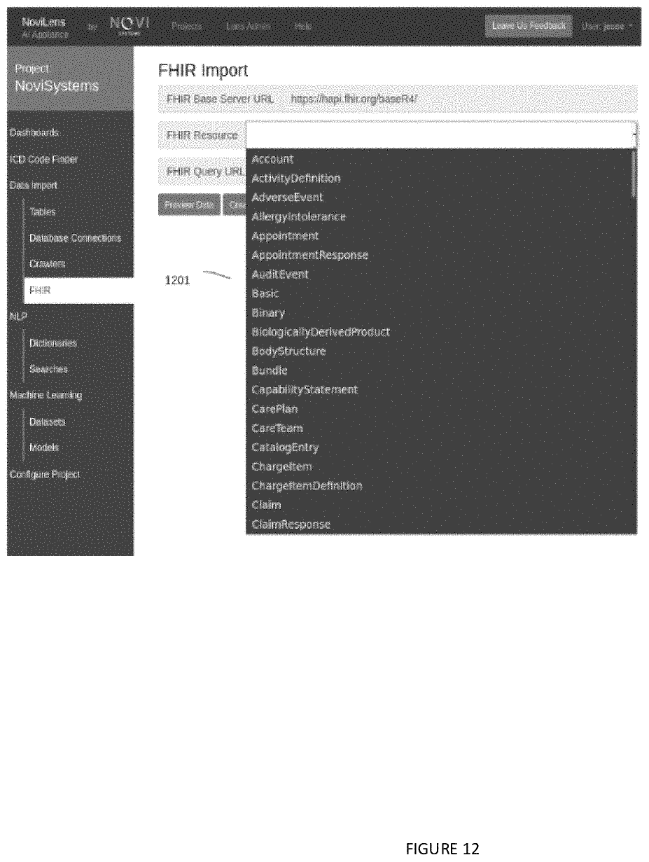

Turning now to FIG. 12, this figure presents an example of the data that can be brought into the system by the FHIR data acquisition system. The list of data or “fields” 1201 is not limited to those displayed by rather serves as an example of the data types available for analysis. Any field present in the FHIR-compliant system can be captured by the system.

Accessing Machine Learning Processes and applying to healthcare data is another innovation of the Healthcare Decision System. The preprocessing routines receive input from a feedback system consisting of a user interface, the data under investigation, and the aforementioned routines. In addition, the system must be informed if the data model required is supervised or unsupervised learning. The user is prompted to characterize the query.

This user input allows the HDP to select the appropriate set of machine learning algorithms to apply to the problem. The data is organized as a series of columns. The selection of a column represents the value a user wants to classify and/or predict without showing how the other data columns or features contribute to the analysis/prediction. This data isolation leads to supervised learning algorithms while a selection of one column of data while requesting data grouping in an attempt to cluster data “likes”, directs the system to unsupervised learning algorithms.

This process represents a significant innovation. While many rules-based systems can perform tasks such as ICD-code matching, the ability to label terms extracted from EMR systems then placed in a Machine Learning system for classification allows the HCP to tune itself over time, becoming more efficient in the labelling process. The HCP has a GUI that allows non-programmers to develop queries of structured and unstructured data processed by the HDP algorithms.

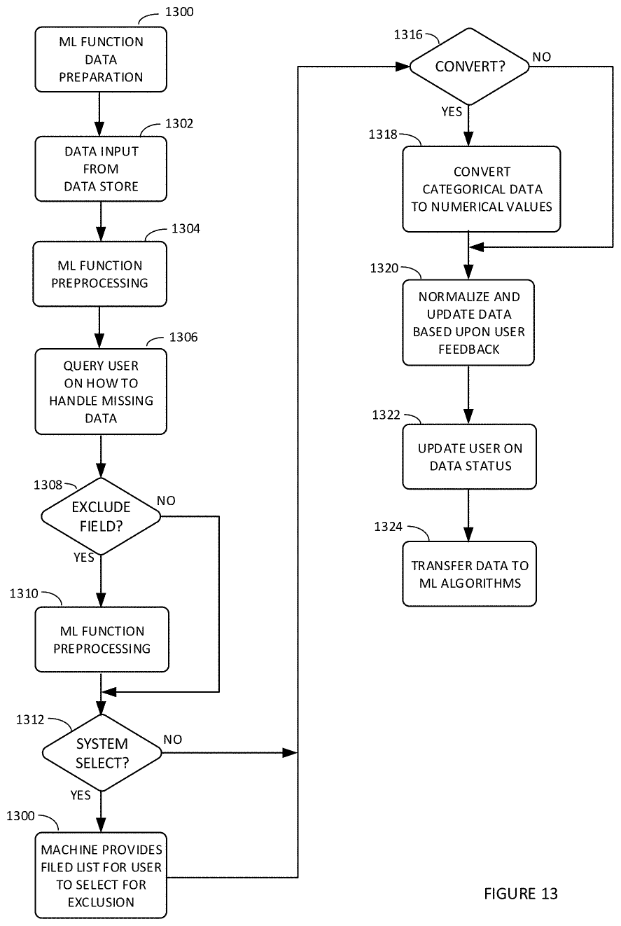

Turning now to FIG. 13, this figure presents a diagram that illustrates the functionality of the machine learning process. The drop down menu system begins with preprocessing data 1300 that has been selected from the data store 1302. This includes statistical analysis of the data as well as determining data type as well as missing values 1304. The user is then queried on how to handle missing data 1306 and if classification of data type is correct 1308. The system then queries the user for the performance of data set reduction algorithms 1310 and presents results to the user for acceptance 1312. The dataset is then further processed 1316 and the user is asked if the finalized dataset needs to be reclassified 1318. Once the response is given, the data is normalized 1320 and the user is informed 1322 that the data is ready for the machine learning algorithm 1324.

The selection of the machine learning algorithms is another innovation of the HCP where the machine prompts the user for information then develops the protocols for tuning and testing various algorithms for accuracy and precision.

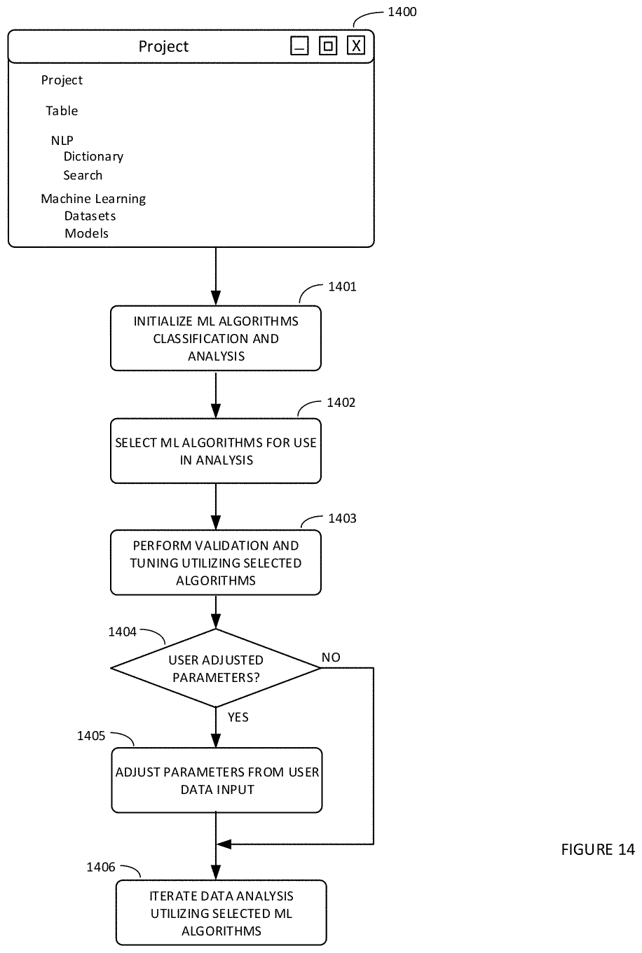

Turning now to FIG. 14, this figure presents an outline of the process for tuning and testing various algorithms for accuracy and precision. Once the datasets have been prepared, the user can select Models from Machine Learning on the Project UI 1400. This initiates a series of pipeline activities 1401, querying the user for the type of analysis that needs to be performed 1402. Once input is received, the machine begins the internal process of splitting data into training and testing sets then performing cross-validation testing 1403. If necessary, the system will up-sample data 1403 to improve performance. A comparison is performed to determine if tuning parameters should be adjusted 1404. Once complete, the accuracy and precision will be presented to the user along with the chance to alter parameters 1405. Once user input is received, the model is developed 1406.

The types of models deployed by the system include regression, support vector machines, decision trees, ensemble methods, distance relationships(vectors), neural networks and their variants. The design of the system allows any machine algorithm to be deployed that accepts data that can be formatted into a table or array, therefore is essentially unconstrained.

To adapt to user preference for data display, the system uses a series of drop down menus to direct the user to add data analysis functions to the display using screen position as a guide where banners place query activities as rows across the top of a page while columns allow the user to configure the display into any number of columns. Each column may contain a separate analytic widget.

The configuration of the data display is referred to as a dashboard. Each dashboard is associated with a primary data table in the data store. The system may either use established primary, foreign key relationships that exist in database tables or the system may generate these relationships in csv files or unrelated data tables imported into the HDP. Automatic dashboard generation increases the user's ability to assess relationships between data sets without the need of a programmer.

In an embodiment, the text tools herein described enable the user to develop models for fact extraction and text classification without a deep understanding of programming. This allows the HCP to extract a wide range of healthcare related facts depending on the knowledge domain of the user. The system relies on the user's expertise in the field to initiate the process and provides feedback to develop models for data extraction and text classification. The system is agnostic and can be used by any subject matter expert.

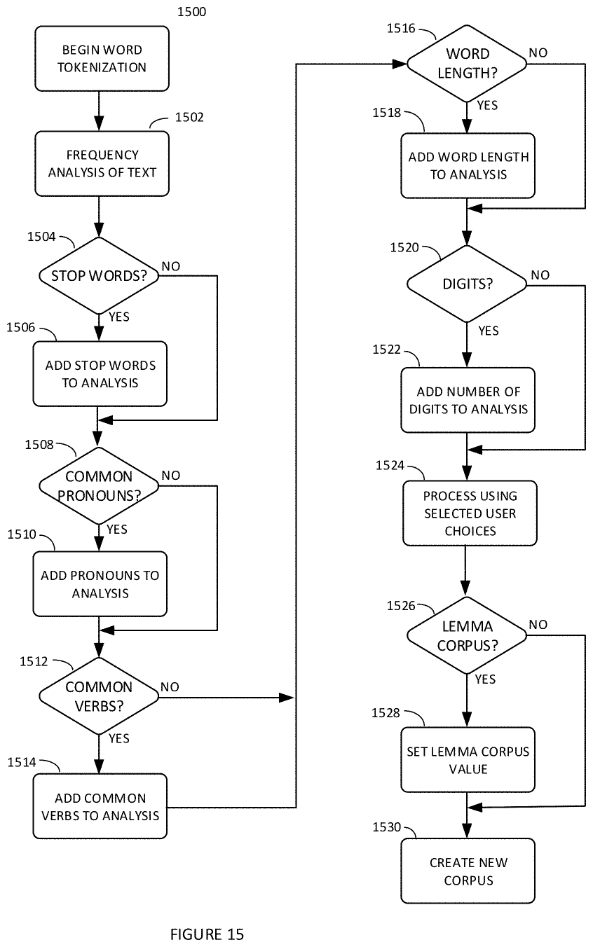

Turning now to FIG. 15, this figure presents a flow diagram for word tokenization and analysis consistent with certain embodiments of the present invention. In this embodiment, the system begins with processing text fields to tokenize words in any imported Data Table. The objective of the text cleaning process is to reduce the number of irrelevant words, terms that have no impact on context or specificity, so that the data set is reduced in size leading to more efficient operation and a greater probability of relevant returns.

The first step in the process is word tokenization 1500. This breaks down the structure of the text data from continuous strings to individual tokens. When tokenization is complete the system performs frequency analysis 1502 of the tokenized text using nitk or other suitable programming tools. This frequency value for each tokenized word may be stored for later use.

At 1504, the system asks if stop words should be included in the analysis. If the user indicates that they should, stop words are included in the analysis by comparing word frequency values to stop word frequency at 1506. The user is also presented with choices by the system to include common pronoun frequency at 1508 and common verb frequency at 1512. If the user elects to include common pronouns and common verbs in the analysis, common pronouns are added to the analysis at 1510 and common verbs are added to the analysis at 1514.

Two additional cleaning steps may be performed if selected. At 1516 the user is asked if word length should be included, and, if elected by the user, the system removes any word less than four letters long with the exception of abbreviations at 1518. At 1520 the user is asked if digits should be removed and, if elected by the user, the system removes a selected number digits from the analysis at 1522. The system processes the Data Table utilizing the user specified selections at 1524 to create a new corpus. At 1526 the system asks the user if the new corpus should be created using the lemma. If the user elects to create a lemma corpus, at 1528 the system sets the lemma corpus value, and the new corpus, regardless of type, is created as the basis corpus at 1530 and can then be used as the basis for machine learning.

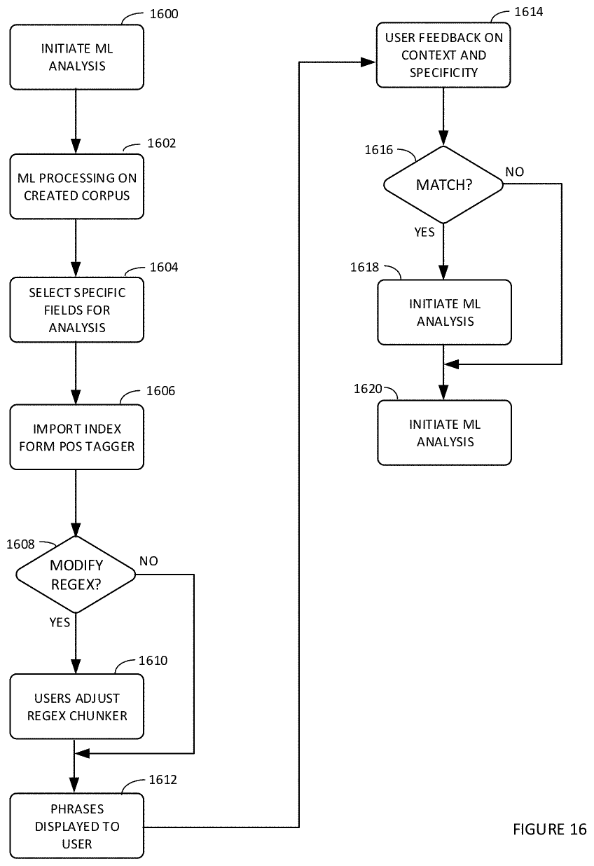

Turning now to FIG. 16, this figure presents a flow diagram for machine language preprocessing to build training data sets consistent with certain embodiments of the present invention. In this embodiment, the system initiates ML analysis at 1600 by performing preprocessing steps on the previously created corpus at 1602. The system selects specific fields for analysis at 1604 and imports the necessary index from a POS tagger at 1606. The system then ingests specific fields of cleaned text and the index from the POS tagger. At 1608 the system inquires if the user wants to modify the regex. If the user selects this option, at 1610 phrases are then generated using a regular expression chunker nitk or similar algorithm. The system has a default regular expression chunker but it can be adjusted by the user. Phrases are displayed to the user at 1612 in order to receive user feedback on specificity and context at 1614.

Following acceptance of the phrases, the POS tagging process is performed on either the lemma derived corpus or basis corpus. Terms from the phrases are compared to terms in the dictionaries for matching values at 1616. One term from any dictionary must be present in a phrase. If there is a match, the phrase will be added to the training data at 1618. At 1620, the system updates the corpus and the updated corpus may be used in the machine learning algorithm for training.

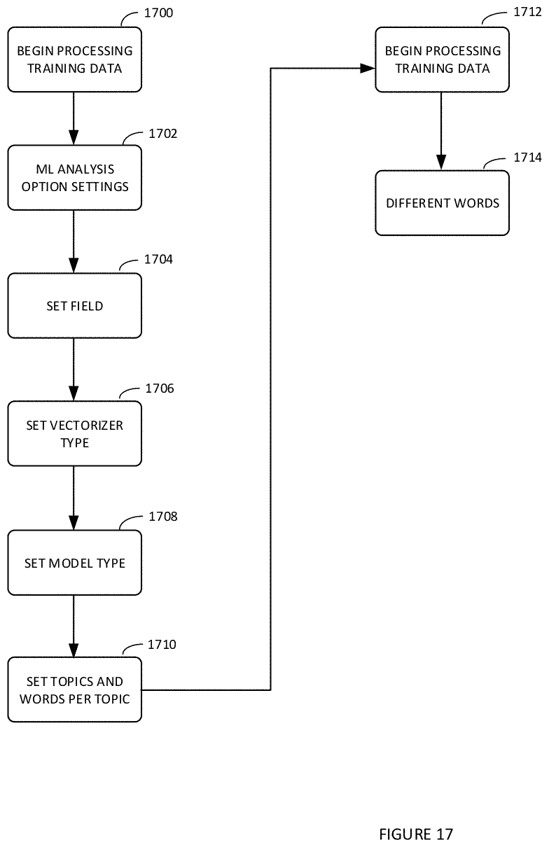

Turning now to FIG. 17, this figure presents a flow diagram for training data processing and use consistent with certain embodiments of the present invention. In this embodiment, the HDP uses multiple machine learning algorithms to process training data. The system may use a number of algorithms including but not limited to Latent Dirichlet Allocation LDA, Non-Negative Matrix Factorization NMF, and Neural Networks NN. Machine Learning begins with processing the training data 1700.

Users of the HDP are instructed to select analysis options from the user interface 1702. The user may select the field to be analyzed at 1704 and the vectorizer type may be selected at 1706. Vectorization converts the text to a numerical array for use in the machine learning algorithms. The vectorizer type can either be a word to vector transformation or term frequency-inverse document frequency vectorization.

Following vectorization, the model type may be selected by the user at 1708. This determines the clustering algorithm that will be run. The selection includes LDA, NMF, and NN as described above. At 1710, the user may select the number of topics and the words per topic to be processed by the system. In a non-limiting example, the number of topics represents the number of clusters or topics that will be isolated by the machine learning algorithm. If the user asks for three topics, the returns will provide a list of terms in clusters that represent terms that cluster in three separate groupings.

This list is compared to the dictionaries and new terms or topics are presented to the user 1712. The user can then elect to add the terms to a new dictionary or append the terms to an existing dictionary 1714.

The combination of NLP and ML with the ability to “read” EMRs without the need of a data scientist represents a novel application and extension of the patent application “An Intelligence Augmentation System for Data Analysis and Decision Making” Docket Number: NOV-npr-001. This HCP is not disease-specific, but rather can be used by any healthcare professional to isolate facts necessary to perform analysis of patients, treatments, care, etc. By allowing the user to filter and label extracts of text from EMRs, the healthcare profession can use complex machine learning algorithms to sort and classify patients. The systems' capabilities to fuse and transform data using the data processing pipeline precludes the need for additional programming resources and can improve the timeliness and accuracy of processes such as quality, operations, and cash flow in the healthcare setting.

While certain illustrative embodiments have been described, it is evident that many alternatives, modifications, permutations and variations will become apparent to those skilled in the art in light of the foregoing description.

We claim:

1. A method for context driven business task annotation, comprising:
receiving context sensitive facts and text classification from a user;
receiving a query characterization from said user;
selection by a data server of one or more analytical Machine Learning algorithms to utilize in analysis of input text;
creating one or more data columns each of which further comprises a context sensitive text value;
said selected Machine Learning algorithms selecting a data column for analysis;
said selected Machine Learning algorithms grouping one or more additional data fields having a contextual similarity to said data column;
said Machine Learning algorithms analyzing said data column and said additional data fields to create annotations to said input business tasks;
said user selecting and attaching said Machine Learning created annotations to said input text and performing business tasks utilizing said annotated business tasks.

2. The method of claim 1, further comprising collecting feedback from said user in response to queries from said data server on how to handle missing data in input context sensitive facts and text classification.

3. The method of claim 1, further comprising splitting input data into training and testing data sets for use in training Machine Learning algorithms to assist in fact classification for newly presented business tasks.

4. The method of claim 1, further comprising optimizing business tasks based on data fusion, machine learning, and Natural Language Processing.

5. The method of claim 3, further comprising presenting accuracy and precision of tuning parameters to said user along with an opportunity to alter parameters for the training model for said Machine Learning algorithms.

6. The method of claim 5, further comprising creating said training model utilizing received user input for said training model parameters.

7. The method of claim 1, further comprising developing models utilizing regression, support vector machines, decision trees, ensemble methods, distance relationships, neural networks and variants of these model types.

8. The method of claim 1, further comprising creating a dashboard where said dashboard is associated with a primary data table as created by said data server.

9. The method of claim 1, further comprising automatically creating said dashboard to generate relationships visible to a user without input or action from a programmer.

10. A system for context driven business task annotation, comprising:
a data processor installed within a data server;
said data processor receiving context sensitive facts and text classification from a user;
said data processor receiving a query characterization from said user;
selection by said data processor of one or more analytical Machine Learning algorithms to utilize in analysis of input text;
said data processor creating one or more data columns each of which further comprises a context sensitive text value;
said selected Machine Learning algorithms operating in said data processor selecting a data column for analysis and grouping one or more additional data fields having a contextual similarity to said data column;
said Machine Learning algorithms analyzing said data column and said additional data fields to create annotations to said input business tasks;
said user selecting and attaching said Machine Learning created annotations to said input text and performing business tasks utilizing said annotated business tasks.

11. The system of claim 10, further comprising collecting feedback from said user in response to queries from said data server on how to handle missing data in input context sensitive facts and text classification.

12. The system of claim 10, further comprising splitting input data into training and testing data sets for use in training Machine Learning algorithms to assist in fact classification for newly presented business tasks.

13. The system of claim 10, further comprising optimizing business tasks based on data fusion, machine learning, and Natural Language Processing.

14. The system of claim 13, further comprising presenting accuracy and precision of tuning parameters to said user along with an opportunity to alter parameters for the training model for said Machine Learning algorithms.

15. The system of claim 14, further comprising creating said training model utilizing received user input for said training model parameters.

16. The system of claim 10, further comprising developing models utilizing regression, support vector machines, decision trees, ensemble methods, distance relationships, neural networks and variants of these model types.

17. The system of claim 10, further comprising creating a dashboard where said dashboard is associated with a primary data table as created by said data server.

18. The system of claim 10, further comprising automatically creating said dashboard to generate relationships visible to a user without input or action from a programmer.
